(19) United States
(12) Patent Application Publication
(10) Pub. No.: US 2023/0047548 A1
(43) Pub. Date: Feb. 16, 2023

(54) AUTOMATED VIDEO HIGHLIGHT GENERATION

(71) Applicant: SportNinja Inc., Palos Verdes, CA (US)

(72) Inventors: Jeffrey Richard Day, Vancouver (CA); Ronald Moravek, Palos Verdes, CA (US)

(73) Assignee: SportNinja Inc., Palos Verdes, CA (US)

(21) Appl. No.: 17/819,123

(22) Filed: Aug. 11, 2022

Related U.S. Application Data
(60) Provisional application No. 63/260,149, filed on Aug. 11, 2021.

(51) Int. Cl. A63F 13/63; G11B 27/031; A63F 13/86

(52) U.S. Cl. CPC A63F 13/63; G11B 27/031; A63F 13/86

(57) ABSTRACT

An apparatus is provided. The apparatus includes a communications interface to receive game data from an external data source and to receive video data from a plurality of video sources. The apparatus also includes a memory storage unit to store the game data and the video data. Furthermore, the apparatus includes an aggregator to select a video from the video data, wherein the video is associated with an event in the game data. The apparatus additionally includes a notification engine to generate a notification to be transmitted via the communications interface.

### CROSS-REFERENCE TO RELATED APPLICATIONS

The present application claims priority to U.S. Provisional Application Ser. No. 63/260,149 titled “System for Automated Video Highlight Generation and Statistic Augmentation”, filed Aug. 11, 2021, which is incorporated by reference herein in its entirety.

### BACKGROUND

Recreational sporting leagues and amateur sporting are organized for many different types of sports and for many different levels of players. Often, the recreational sporting leagues are operated by non-profit organizations using notebooks or spreadsheets to keep track of game results and some statistics. Recently, programs and software have been developed to help keep track of scores and team records.

### SUMMARY

In accordance with an aspect of the invention, there is provided an apparatus. The apparatus includes a communications interface to receive game data from an external data source and to receive video data from a plurality of video sources. The apparatus includes a memory storage unit to store the game data and the video data. The apparatus includes an aggregator to select a video from the video data, wherein the video is associated with an event in the game data. The apparatus includes a notification engine to generate a notification to be transmitted via the communications interface.

The game data and the video data may include timestamp information. The aggregator may use the timestamp information to associate the video with the event. The timestamp information may be based on a time standard. The aggregator may select a plurality of videos from the video data, wherein each video of the plurality of videos is associated with the event. Each video of the plurality of videos may be captured from a different point of view. The apparatus may further include a content generation engine to generate a highlight clip from the plurality of videos. The game data may be received from a plurality of external data sources, wherein the plurality of external data sources includes the external data source. The apparatus may also include an authenticator to authenticate the game data received from each external data source of the plurality of external data sources.

In accordance with another aspect of the invention, there is provided a method. The method involves receiving, via a communications interface, game data from an external data source. The method also involves receiving, via the communications interface, video data from a plurality of video sources. The method also involves storing the game data and the video data in a memory storage unit. The method also involves selecting a first video from the video data, wherein the first video is associated with an event in the game data. The method also involves generating a notification if the event. The method also involves transmitting the notification to a user device.

Selecting the first video may involve associating the first video with the event based on a timestamp. The method may further involve selecting a second video from the video data, wherein the second video is associated with the event in the game data. The method may further involve generating a highlight clip from the first video and the second video. Receiving the game data may involve receiving the game data from a plurality of external data sources, wherein the plurality of external data sources includes the external data source. The method may further involve authenticating the game data received from each external data source of the plurality of external data sources.

In accordance with another aspect of the invention, there is provided a non-transitory computer readable medium encoded with codes to direct a processor. The processor is directed to receive, via a communications interface, game data from an external data source. The processor is directed to receive, via the communications interface, video data from a plurality of video sources. The processor is directed to store the game data and the video data in a memory storage unit. The processor is directed to select a first video from the video data, wherein the first video is associated with an event in the game data. The processor is directed to generate a notification if the event. The processor is directed to transmit the notification to a user device.

The codes may direct the processor to select a second video from the video data, wherein the second video is associated with the event in the game data. The codes may direct the processor to generate a highlight clip from the first video and the second video. The codes may direct the processor to receive the game data from a plurality of external data sources, wherein the plurality of external data sources includes the external data source. The codes may direct the processor to authenticate the game data received from each external data source of the plurality of external data sources.

### BRIEF DESCRIPTION OF THE DRAWINGS

Reference will now be made, by way of example only, to the accompanying drawings in which:

FIG. 1 is a schematic representation of the components of an example apparatus to receive and associate video to a game event;

FIG. 2 is a schematic representation of the components of another example apparatus to receive and associate video to a game event;

FIG. 3 is a schematic representation of the components of another example apparatus to receive and associate video to a game event;

FIG. 4 is a schematic representation of a system with the apparatus of FIG. 1 to collect data and to associate video to a game event;

FIG. 5 is a schematic representation of another system with the apparatus of FIG. 3 to collect data and to associate video to a game event;

FIG. 6 is a flowchart of an example of a method of receiving and associating video to a game event;

FIG. 7A is a screenshot of an application executed on an external device;

FIG. 7B is another screenshot of an application executed on an external device;

FIG. 7C is another screenshot of an application executed on an external device; and

FIG. 8 is a flowchart of another example of a method of receiving and associating video to a game event.

### DETAILED DESCRIPTION

Various applications and software may allow for organizers of recreational sports leagues to keep track of statistics and other information about a league. This allows the participants in the recreational league to track and monitor the performance of themselves and/or other participants. In some examples, the statistics and other information may provide the feel of a professional league where more resources may be available to track and present data.

It is to be appreciated that in leagues with more resources, more data may be collected and/or stored and presented to provide a better experience for the participants. In some leagues, image, audio, and video data may be collected by organizers or referees to be provided to the participants. In most of these examples, the collection and organization of image and video data is time intensive and carried out manual by an organizer of the league.

In the examples provided herein, an apparatus, system, and method is provided to collect data from multiple users that may include image, audio, and video data associated with a game in a recreational league. The apparatus may automatically generate sports highlight clips or audio content and associated with other game data, such as events during a game. This may be carried out by utilizing a time-stamped statistical data and a player-based data. The apparatus may also automatically encode live or pre-recorded game video content with game-based events along with relevant statistical information pertaining to the event. In addition, the apparatus may generate notifications of game highlight clips to users and other participants to increase engagement with the recreational league.

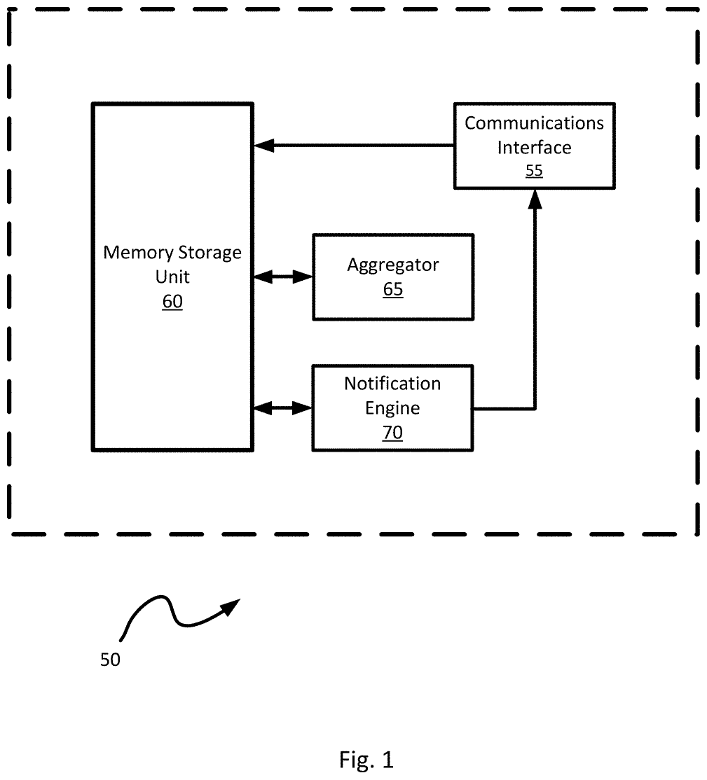

Referring to FIG. 1, an example of an apparatus to receive and associate video to a game event is generally shown at 50. The apparatus 50 may include additional components, such as various interfaces to communicate with other devices, and further input and output devices to interact with a user or an administrator with access to control the apparatus 50. In the present example, the apparatus 50 includes a communications interface 55, a memory storage unit 60, an aggregator 65, and a notification engine 70. Although the present example shows the aggregator 65 and the notification engine 70 as separate components, in other examples, the aggregator 65 and the notification engine 70 may be part of the same physical component such as a microprocessor configured to carry out multiple functions, or combined in a plurality of microprocessors.

The communications interface 55 is to communicate with external devices connected to a network. The external devices are not particularly limited and each device may be considered a data source for the apparatus 50. The exact number of external devices with which the communications interface 55 communicates is not limited. In addition, the external devices may be connected via different networks accessible by the communications interface 55. In the present example, an external device may be an external data source to provide game data. The external device may also be a video source to provide video data. It is to be appreciated by a person of skill with the benefit of this description that each external device may operate as both an external data source to provide game data as well as a video source. For example, an application operating on a portable electronic device, such as a smart phone, may be capable of allowing a user to enter game data into the application in a first mode. The application may also be operated in a second mode allowing it to capture image, audio, and/or video data in real time or collected from a memory of the portable electronic device. In other examples, the external device may be a dedicated external data source for game data, such as a data entry machine without a camera. Alternatively, the external device may be a dedicated video source, such as a camera recording the game.

The manner by which each external device provides data to the communications interface 55 is not particularly limited. For example, some external devices may transmit data to the apparatus 50 periodically. In other examples, external devices may send a data upon receiving a request from the apparatus 50. The data received by the communications interface 55 may include predetermined information, such as data associated with a game, timestamp information, participant identifier location, event type, images, audio, video, or other information.

In the present example, game data received by the communications interface 55 is not particularly limited and may include information about a game such as statistics and scoring. For example, game data may include a scorecard showing goals, penalties, plays, timeouts, or other game statistics. The game data may be entered by a scorekeeper authorized by the league or by participants into an application on a portable electronic device, which subsequently transmits the game data to the apparatus 50.

The video data may include videos with or without audio captured by a camera. It is to be appreciated by a person of skill with the benefit of this description that the video data may be replaced with image data in some examples. Accordingly, video data may include image data. The videos are not particularly limited and may be captured using a camera or any device with a camera. For example, the video may be captured using a portable electronic device with a built-in camera via an application in real time. Alternatively, the application may have access to the video library of the portable electronic device where the application can search and retrieve videos and images associated with a game to transmit to the apparatus 50.

The memory storage unit 60 is to store the game data and the video data received from the external data sources via the communications interface 55. The manner by which the game data and the video data are stored is not particularly limited. For example, the memory storage unit 60 may maintain a database where each of the game data and the video data may be stored and indexed. In particular, the game data and the video data in the database may include various information such as the data source from which a data record was received as well as timestamp information and other information about the game and/or events associated with the data record.

The memory storage unit 60 may be also used to store addition data to be used by the apparatus 50. For example, the memory storage unit 60 may store various data that extends beyond the game data. For example, the memory storage unit 60 may store historical data about a team or participant in the league. In such an example, it is to be appreciated by a person of skill with the benefit of this application, that the game data received from an external device may be used to update or amend the historical data, such as a team record or the amount of point attributed to a participant.

It is to be appreciated that the memory storage unit 60 may be a physical computer readable medium used to maintain databases, or may include multiple mediums that may be distributed across one or more external servers, such as in a central server or a cloud server. In some examples, the memory storage unit 60 may be preloaded with data, such as instructions, to operate components of the apparatus 50. In other examples, the instructions may be loaded via the communications interface 55 or by directly transferring the instructions from a portable memory storage device connected to the apparatus 50, such as a memory flash drive.

In the present example, the memory storage unit 60 is not particularly limited and may include a non-transitory machine-readable storage medium that may be, for example, an electronic, magnetic, optical, or other physical storage device. In the present example, the memory storage unit 60 is a persistent memory that may also store an operating system that is executable by a processor to provide general functionality to the apparatus 50. Furthermore, the memory storage unit 60 may be encoded with codes to direct the processor to carry out specific steps to perform a method described in more detail below. The memory storage unit 60 may additionally store instructions used by a processor to operate at the driver level and to communicate with other components and peripheral devices of the apparatus 50. Furthermore, the operating system may provide functionality to additional applications operating on the apparatus 50.

The aggregator 65 is to select a video from the video data received via the communications interface 55 from a video source and to associate the video with an event in the game data received via the communications interface 55 from an external data source. The event in the game data is not particularly limited and may be defined as a data record that meets a predetermined set of criteria. While the game data may include records describing various plays and actions throughout a game, such as a scorecard in baseball, many such plays will not be considered an event. However, a predetermined list of plays, such as a home run or strikeout may be defined as an event for the purposes of the apparatus 50. The definition of what is to be considered an event may be varied and set by a league organizer or other administrator. In other examples, events may be defined by a participant or user of an application entering the game data.

The manner by which the aggregator 65 selects the video to associate with and the event is not particularly limited. For example, a video may be received by the apparatus 50 with an identifier to link the video to an event. In another example, each event and video stored in the memory storage unit 60 may include timestamp information. For examples, where the apparatus 50 receives game data from multiple games and/or locations, the game data may include a game identifier or location for each event and each video stored in the memory storage unit 60 may also include a game identifier or location information. The aggregator 65 may search the database in which the videos are stored to find a video with overlapping timestamp information as the timestamp information of the event. The aggregator 65 may then associate the video with the event for subsequent processing. It is to be appreciated by a person of skill in the art with the benefit of this description that the game data and the video may be received from different external devices that may use different formats for timestamp information. Furthermore, in some examples, the game data may not be recorded in real time. Accordingly, to compare timestamp information from different data records and/or videos, a time standard is defined and used by the apparatus 50. As an example of a time standard, data records stored in the memory storage unit 60 may include a standard time, such as coordinate universal time (UTC).

In further examples, the aggregator 65 may be used to select a plurality of videos from the video data. Since the video data may include multiple videos from multiple video sources, it is to be appreciated that an event may be associated with more than one video. For example, if two portable electronic devices capture video at the same time of a play determined to be an event, both videos may capture the event. In such an example, if the portable electronic devices are located at different locations, such as different seats in an arena, the videos of the event captured from the different video sources may provide a different point of view that can diversify the angles from which the event can be viewed.

It is to be appreciated by a person of skill in the art with the benefit of this description that the aggregator 65 is to combine videos stored in the memory storage unit 60 with identified events. The aggregator 65 may generate another database of events with videos. It is to be appreciated that some events may not have associated video. For example, the aggregator 65 may not find suitable videos, such as a video with matching timestamp information in the video database. In some examples, the aggregator 65 may find a single video from the video database. When more than one video can be associated with the event, the aggregator 65 may select the most appropriate video, such as one with a good angle of view, to associate with the event. In other examples, the aggregator 65 may select a plurality of videos from the video database. The aggregator 65 may have a threshold number of videos or may continue searching and associating videos from the database until no more matching videos are found.

The notification engine 70 is to generate a notification to be transmitted to an external device via the communications interface 55. The notification may be send in response to a request from the external device in some examples. In other examples, the notification engine 70 may automatically push notifications to external devices when predefined criteria are met. For example, a notification may be transmitted for each event. In other examples, a notification may be transmitted only when a video is associated with an event.

The notification generated is not particularly limited. For example, the notification may activate an alarm or indicator through an application on a portable electronic device. In other examples, a message may be broadcasted to the portable electronic device. By generating a notification, the apparatus 50 provides an indication to a user use an application to review the game data and/or additional videos uploaded by other participants.

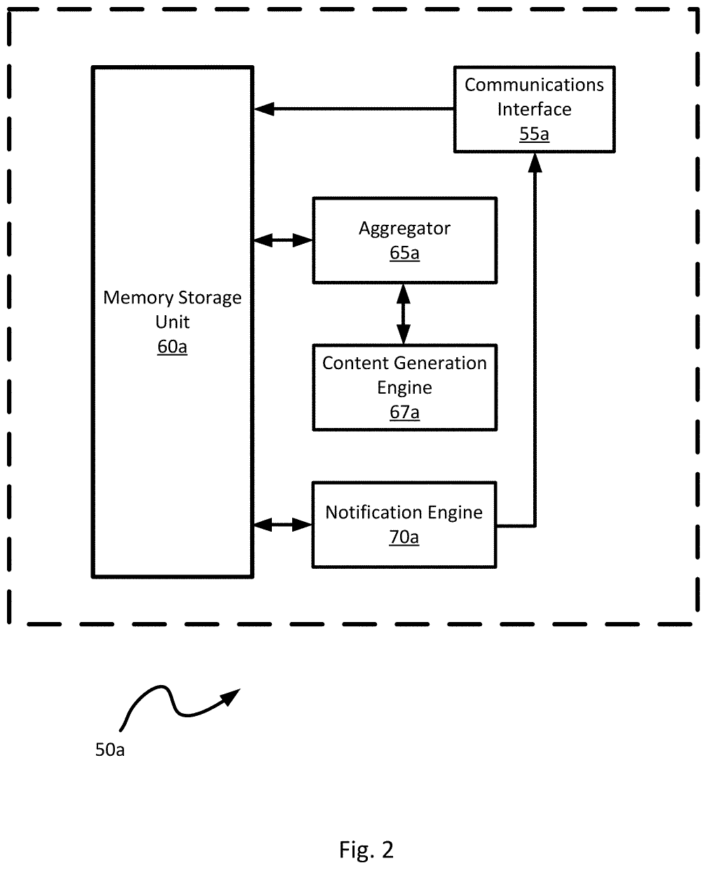

Referring to FIG. 2, another example of an apparatus 50a to receive and associate video to a game event is generally shown. Like components of the apparatus 50a bear like reference to their counterparts in the apparatus 50, except followed by the suffix “a”. In the present example, the apparatus 50a includes a communications interface 55a, a memory storage unit 60a, an aggregator 65a, a content generation engine 67a, and a notification engine 70a.

In the present example, the apparatus 50a includes a content generation engine 67a. The content generation engine 67a is to receive a plurality of videos selected from the aggregator 65a and to generate a highlight clip associated with the event. The highlight clip generated is not particularly limited. For example, the content generation engine 67a may receive a plurality of videos of different viewpoints and of different lengths associated with the event. The content generation engine 67a may combine the videos into the highlight clip to show the event similar to a professional highlight reel. The manner by which the content generation engine 67a generates the highlight clip is not particularly limited. For example, the content generation engine 67a may allow for an external editor to review and edit the videos clips. In other examples, the content generation engine 67a may automatically generate the clip base on metadata associated with each video, such as the location, video quality, or the specific external device identified by a login process on an application. For example, some users may be associated with better videos based on their historical uploads and preferred over other videos. In further examples, the content generation engine 67a may use image processing software or machine learning techniques to analyze the plurality of videos and curate videos for the highlight clip. It is to be appreciated by a person of skill with the benefit of this description that the highlight clip may include various effects such as zooming, slow-motion, or collaging of videos by the content generation engine 67a.

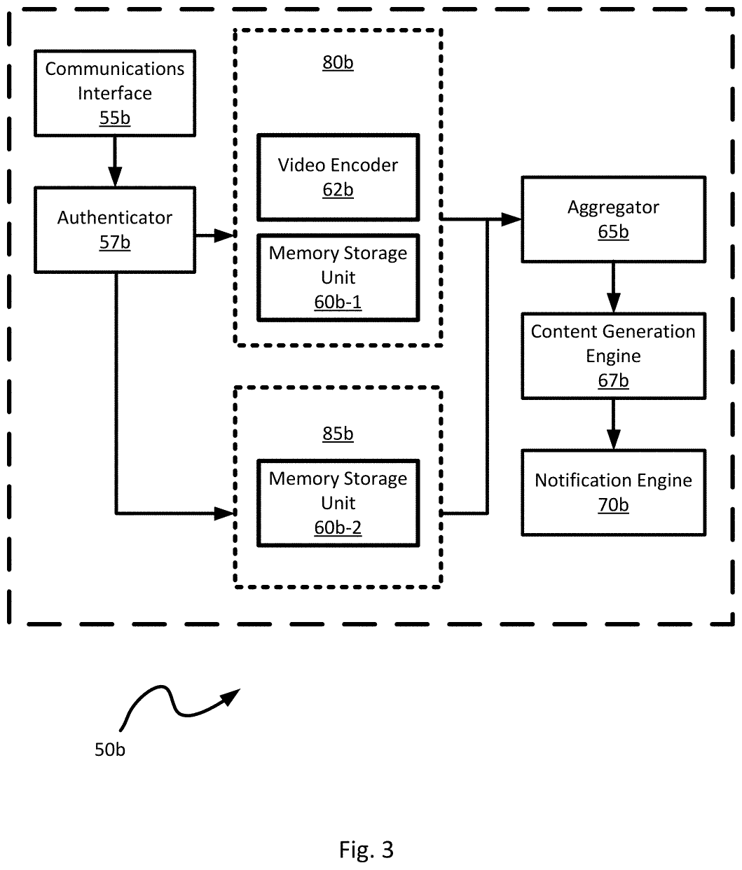

Referring to FIG. 3, another example of an apparatus 50b to receive and associate video to a game event is generally shown. Like components of the apparatus 50b bear like reference to their counterparts in the apparatus 50a, except followed by the suffix “b”. In the present example, the apparatus 50b includes a communications interface 55b, an authenticator 57b, an aggregator 65b, a content generation engine 67b, a notification engine 70b, a video processor 80b with a memory storage unit 60b-1 and a video encoder 62b, and a game data processor 85b, with a memory storage unit 60b-1.

In the present example, the apparatus 50b includes a video processor 80b and a game data processor 85b. The video processor 80b and the game data processor 85b are not particularly limited. In the present example, the video processor 80b and the game data processor 85b may be separate server systems connected via a network. In other examples, the video processor 80b and the game data processor 85b may be operated on a single machine with sufficient computational resources to handle the game data and the video data.

The video processor 80b includes a memory storage unit 60b-1 to store videos received via the communications interface 55b. The video processor 80b further includes a video encoder 62b to encode the video data received from external devices. It is to be appreciated by a person of skill with the benefit of this description that video may be recorded with any hardware camera and that the video may be received by the video encoder 62b via a wireless connection of via a video signal through a cable, such as HDMI. The video encoder 62b encodes the video into a standard format for the video processor 80b in real-time for further processing. In other examples, the video received from the external device may already be encoded by the device. The encoding carried out on the external device may be carried out with a native application or the application specific to the apparatus 50b prior to transmission.

The game data processor 85b includes a memory storage unit 60b-2 to store game data received via the communications interface 55b. In the present example, game data may be received from multiple external data sources. For example, multiple users may be tasked with providing game data to the apparatus 50b. In some examples, this may provide for redundancy and game data integrity. In other examples, different individuals or officials may be responsible for collecting different game data. For example, a scorekeeper may be responsible for collecting score information and a referee may be responsible for collecting penalty information. Examples of game data that may be handled by the game data processor 85b includes parameters of the game, such as game length, period length, date started, date ended, and in game-based data, such as goals scored, shots made, and penalties.

The authenticator 57b is to authenticate the game data received from an external data source. in the present example, the authenticator 57b may determine if the game data is received from an external data source with the correct credentials to modify the information in the game data processor 85b. For example, prior to sending game data through to the apparatus 50b, a user of an external device may log into an account on an application running on the external device. In this example, the authenticator 57b looks at the rights of the account holder from which the game data is receive. It is to be appreciated by a person of skill that assigning rights to submit game data may be set by administrators of the recreational league. For example, some account types, such as game officials, may be permitted to submit and edit any type of game data. Other types of account types may limit the parameters that may be edited or subject changes to approval by another account. As an example, some accounts may be limited to adding individual player statistics, such as goals or points.

It is to be appreciated that the apparatus 50b may provide content such as statistics, videos, and highlight clips to a portable electronic device. For example, the apparatus 50b may receive requests from a device via a network. The request may be from an application executed on the external device requesting game event-based data, such as statistics, game highlight clips, and video either in real time as the game is occurring, or after the game has completed. The requester may be a participant or spectator in a recreational league with limited rights. For example, the requester may be authorized to obtain certain game data or video data, such as data associated with a team. In such an example, the authenticator 57b may authenticate the credentials of the participant or spectator, who may have access to some of the game data and video data, and provide the requested content or deny the request based on the rights of the requestor.

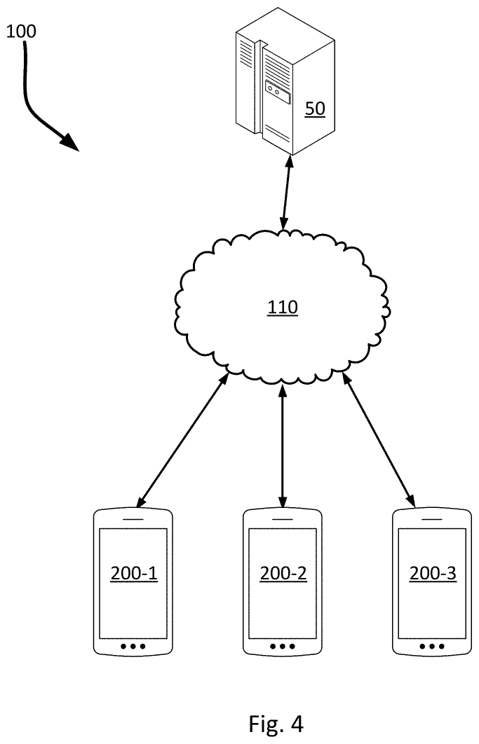

Referring to FIG. 4, an example of a system 100 to process video data and game data is generally shown. In the present example system 100, the apparatus 50 is in communication with a plurality of external devices 200-1, 200-2, and 200-3 (generically, these external devices are referred to herein as “external device 200” and collectively they are referred to as “external devices 200”) via a network 110. It is to be appreciated by a person of skill that the network 110 is not particularly limited and may be any wired or wireless network connecting the external devices 200 to the apparatus 50. For example, the network 110 may be the Internet to connect the external devices 200 and apparatus 50. In other examples, the network 110 may be an intranet or other type of closed and/or private network.

In the present example, the external devices 200 may be any type of electronic device, such as a smartphone, a tablet, a laptop, a desktop computer, a television, virtual reality device, or any other device capable of receiving user input to and generating user output. The external devices 200 may execute an application that allows for multiple functionality. For example, the application running on each external device 200 may allow the user to submit game data, submit video data, or request data from the apparatus 50 based on the credentials of the user account logged into the application.

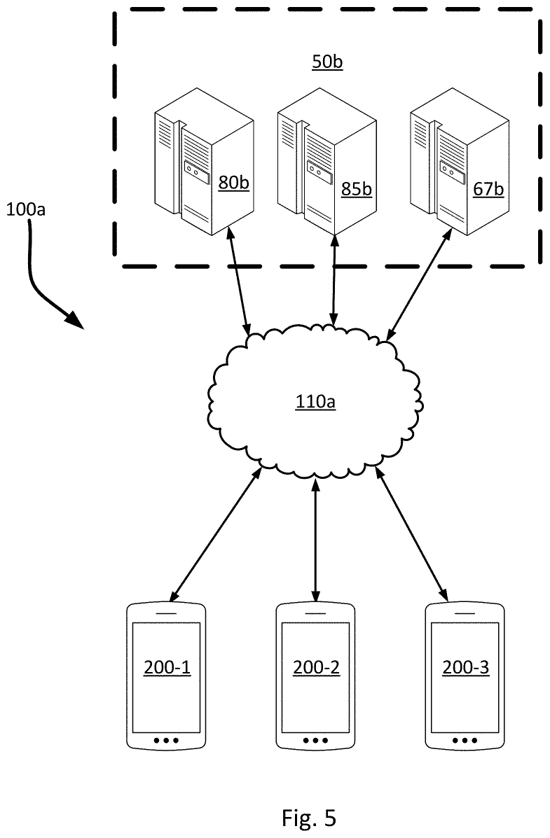

Referring to FIG. 5, another example of a system 100a to process video data and game data. Like components of the system 100a bear like reference to their counterparts in the system 100, except followed by the suffix “a”. In the present example system 100a, the apparatus 50b is in communication with a plurality of external devices 200-1, 200-2, and 200-3 via a network 110a. It is to be appreciated by a person of skill that the network 110a may be similar to the networks described above in connection with the network 110a.

In the present example, the external devices 200 may send requests to each of the video processor 80b, the game data processor 85b, or the content generation engine 67b of the apparatus 50b. Accordingly, depending on the functionality provided by the application running on the external device 200, the external device 200 may communicate directly with the video processor 80b, game data processor 85b, or the content generation engine 67a. For example, if the application is in a video submission mode, the external device 200 may submit videos directly to the video processor 80b. In some examples, the application may also allow the external device 200 to request video data from the video processor 80b. In another example, if the application is in a game scoring mode, the external device 200 may submit game data directly to the game data processor 85b. The application may allow for a spectator role where the external device 200 may request game data from the game data processor 85b. In addition, the application may also provide the viewing of highlight clips associated with game events. Accordingly, the external device 200 may submit a request for highlight clips from the content generation engine 67b. In some examples, the application may automatically download a highlight clip from the content generation engine 67b to be associated with an event when presenting game data from the game data processor 85b.

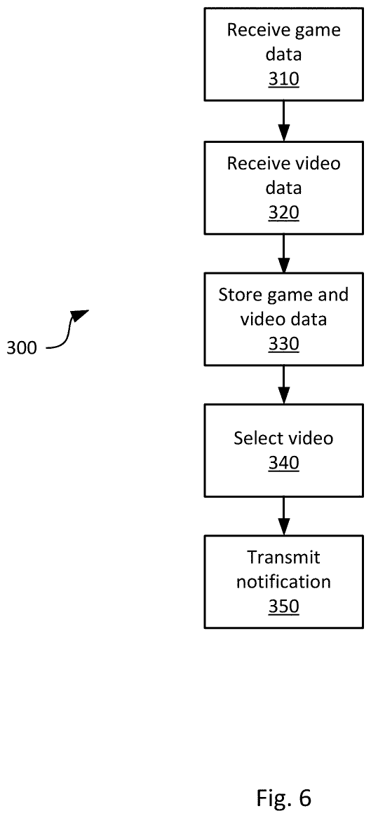

Referring to FIG. 6, a flowchart of an example method of receiving and associating video to a game event is generally shown at 300. In order to assist in the explanation of method 300, it will be assumed that method 300 may be performed by the apparatus 50. Indeed, the method 300 may be one way in which the apparatus 50 may be configured. Furthermore, the following discussion of method 300 may lead to a further understanding of the apparatus 50 and it components. In addition, the method 300 may not be performed in the exact sequence as shown, and various blocks may be performed in parallel rather than in sequence, or in a different sequence altogether.

Beginning at block 310, the apparatus 50 receives game data from an external source via the communications interface 55. The game data received at block 310 is not particularly limited and may include information about a game such as statistics and scoring. For example, game data may include a scorecard showing goals, penalties, plays, timeouts, or other game statistics. The game data may be entered by a scorekeeper authorized by the league or by participants into an application on a portable electronic device.

Block 320 involves receiving video data from a plurality of video sources. The video data may include videos with or without audio captured by a camera. The videos are not particularly limited and may be captured using a camera or any device with a camera. For example, the video may be captured using a portable electronic device with a built-in camera via an application in real time. Alternatively, the application may have access to the video library of the portable electronic device where the application can search and retrieve videos and images associated with a game.

Once received at the apparatus 50, the game data and the video data are stored in the memory storage unit 60 at block 330.

Block 340 involves selecting a video received at block 320 and associating the video with a data record in the game data received at block 310 with the aggregator 65. In the present example, the video is to be associated with a data record that meets the criteria of an event. The event in the game data is not particularly limited and may be defined as a data record that meets a predetermined set of criteria. While the game data may include records describing various plays and actions throughout a game, such as a scorecard in baseball, many such plays will not be considered an event. In the present example, a predetermined list of plays, such as a home run or strikeout may be defined as an event for the purposes of block 340.

Upon selecting the video at block 340, a notification of the game event and video is generated and transmitted to an external device at block 350.

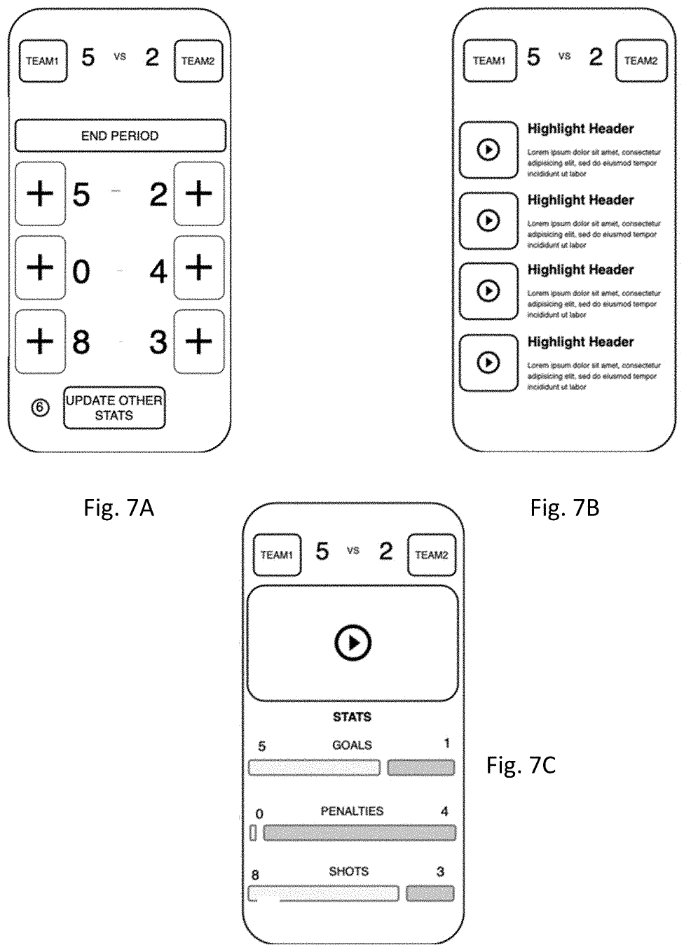

Referring to FIGS. 7A, 7B, and 7C, screen shots of an application running on an external device 200, such as a portable electronic device is shown. In FIG. 7A, the application in a game scoring mode may be used by game officials such as referees and scorekeepers to track and input game data, identify events, and other dependent information. In the present example, the game data may be encoded with available information such as location, and timestamp information obtained from the external device 200, such as from a GPS receiver and internal clock. Examples of dependent information may include the name of each team playing the current game along with the current score, segment of the game, time remaining for the segment, and total time remaining in the game. In the present example, a set of button inputs displayed allow the user to input primary game data. Primary game data is defined as a set of in-game occurrences used to score a game such as goals scored, or player penalties. Once the selected primary game data has been inputted, supporting data inputs may be displayed for the user to input on a secondary step. In some examples, the primary game data is displayed on generated game scorecards upon post-game processing. Secondary game data may also be inputted via a button in the lower half of the screen. In the present example, secondary game data is defined as non-critical game occurrences such as player position changes and injury reports. Secondary game data may be omitted when complete game scoring. However, secondary game data may add additional metadata when generating statistics to enhance the quality of the highlight descriptions. Secondary game data may also be displayed on generated game scorecards upon post-game processing.

Referring to FIG. 7B, a user with viewing rights, such as a spectator or participant may be presented with access to in-progress and post-completed games to view automatically generated video highlight clips along with associated generated text highlight clips. Upon selecting a highlight header to review, the user can access video of the game event along with associated statistics for the game, team, and player as shown in FIG. 7C. It is to be appreciated that the video and events may be viewed in real time as they happen or at a subsequent time when reviewing the game.

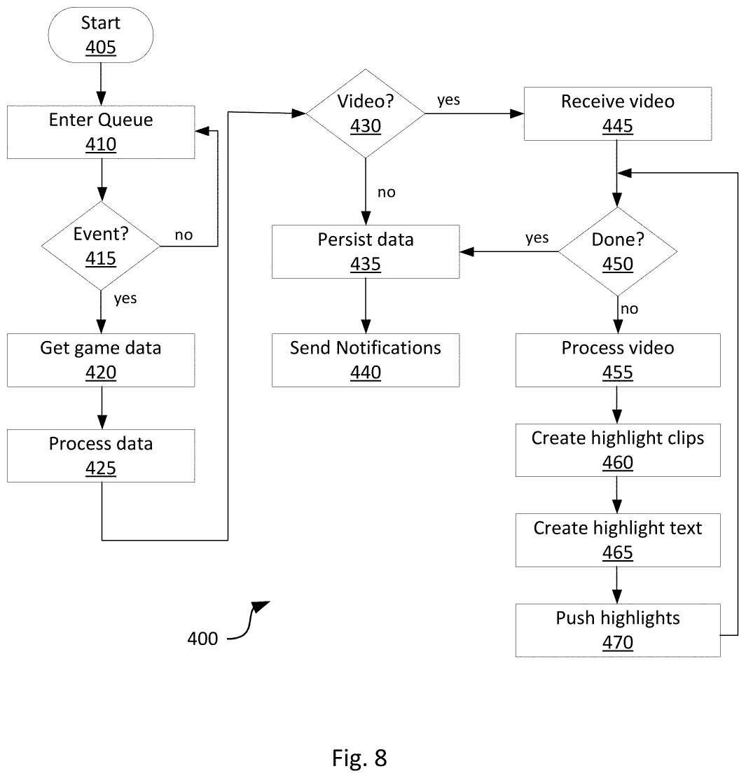

Referring to FIG. 8, a flowchart of another example method of receiving and associating video to a game event is generally shown at 400. In order to assist in the explanation of method 400, it will be assumed that method 400 may be performed by the apparatus 50.

In the present example, the method 400 begins at block 405 by listening for incoming requests and submits valid statistical events to a queue mechanism at block 410. The apparatus continues to collect valid statistical events at block 415. When the queue receives the statistic event, the apparatus 50 unpacks event-based data and retrieves relevant data objects such as game data, team data and statistics collections, player data and statistics collections from the persistent database at block 420.

Once the game data has been retrieved, the apparatus 50 iterates through each applicable statistic to be processed for the game at block 425. Each individual statistic that is processed has its a dependency list that enforces the order in which statistics will be processed. For example, Goals Scored is to be calculated before average team goals can be calculated.

Next, the apparatus 50 checks to determine if there is available video data at block 430. If there are no videos, the data is persisted at block 435 and notifications are sent at block 440 to the external device 200.

If there is video data available as determined at block 430, the apparatus 50 handles a highlight generation request for each video. Each available game video may be submitted for processing where the apparatus uses game event timestamp data to infer start and end times at block 455. These time references are used to create unique clips derived from the current game video being processed at block 460. Once the highlight clips have been generated and the related data records have been persisted, the game, team, and player statistics are updated to reference the related highlight clips to be used when linking them within the spectator web and mobile application.

The highlight text is generated using available game statistical data at block 465 and notifications are sent out via mobile push notification and email to users who had previously subscribed for game highlight events at block 470.

Various advantages will not become apparent to a person of skill in the art. In particular, the apparatus 50 may provide to a platform and application that may use a smartphone or camera to collect video and data from a game. The video and game data may be collected continuously from a camera in a sports arena, or the video data and the game data may be collected by a user through a mobile device (such as a smartphone). The application is designed to be used by multiple external devices 200 allowing video to be recorded from multiple sources/viewpoints, and statistical game data such as scoring, penalties, and goals to be concurrently processed in real-time. The application running on the external devices 200 may connect to a backend cloud-based or hosted application server, such as the apparatus 50, that processes statistic event requests, calculates game-based statistics for the game, teams, and players involved. The application running on the external devices 200 may also record live video data and transmits this to the apparatus 50 where it is persisted.

While the game events are being processed, the apparatus 50 may check to see if video data exists for the current event and initiates a video processing mechanism used to automatically calculate the game event start and end timestamps and then create highlight clips. The mechanism may also provide ‘sportscaster’ like highlight text by utilizing game event data for the game, team, and players involved. Through this process, video data and game data include persistent references to each event that occurred within the game that can be accessed by users in real-time or post-game viewing. Accordingly, the apparatus 50 may provide features to other users who want to follow the game through the application such that they are presented with highlight clips of some game events, in the form of video and text-based highlights. Relevant game-based highlights may also be sent to users via mobile push notification or email linking them to the specific highlight clips.

It should be recognized that features and aspects of the various examples provided above may be combined into further examples that also fall within the scope of the present disclosure.

What is claimed is:

1. An apparatus comprising:
a communications interface to receive game data from an external data source and to receive video data from a plurality of video sources;
a memory storage unit to store the game data and the video data;
an aggregator to select a video from the video data, wherein the video is associated with an event in the game data; and
a notification engine to generate a notification to be transmitted via the communications interface.

2. The apparatus of claim 1, wherein the game data and the video data includes timestamp information.

3. The apparatus of claim 2, wherein the aggregator uses the timestamp information to associate the video with the event.

4. The apparatus of claim 3, wherein the timestamp information is based on a time standard.

5. The apparatus of claim 1, wherein the aggregator selects a plurality of videos from the video data, wherein each video of the plurality of videos is associated with the event.

6. The apparatus of claim 5, wherein each video of the plurality of videos is captured from a different point of view.

7. The apparatus of claim 6, further comprising a content generation engine to generate a highlight clip from the plurality of videos.

8. The apparatus of claim 1, wherein the game data is received from a plurality of external data sources, wherein the plurality of external data sources includes the external data source.

9. The apparatus of claim 8, further comprising an authenticator to authenticate the game data received from each external data source of the plurality of external data sources.

10. A method comprising:
receiving, via a communications interface, game data from an external data source;
receiving, via the communications interface, video data from a plurality of video sources;
storing the game data and the video data in a memory storage unit;
selecting a first video from the video data, wherein the first video is associated with an event in the game data;
generating a notification if the event; and
transmitting the notification to a user device.

11. The method of claim 10, wherein selecting the first video comprises associating the first video with the event based on a timestamp.

12. The method of claim 10, further comprising selecting a second video from the video data, wherein the second video is associated with the event in the game data.

13. The method of claim 12, further comprising generating a highlight clip from the first video and the second video.

14. The method of claim 10, wherein receiving the game data comprises receiving the game data from a plurality of external data sources, wherein the plurality of external data sources includes the external data source.

15. The method of claim 14, further comprising authenticating the game data received from each external data source of the plurality of external data sources.

16. A non-transitory computer readable medium encoded with codes, wherein the codes are to direct a processor to:
receive, via a communications interface, game data from an external data source;
receive, via the communications interface, video data from a plurality of video sources;
store the game data and the video data in a memory storage unit;
select a first video from the video data, wherein the first video is associated with an event in the game data;
generate a notification if the event; and
transmit the notification to a user device.

17. The non-transitory computer readable medium of claim 16, wherein the codes are to direct the processor to select a second video from the video data, wherein the second video is associated with the event in the game data.

18. The non-transitory computer readable medium of claim 17, wherein the codes are to direct the processor to generate a highlight clip from the first video and the second video.

19. The non-transitory computer readable medium of claim 16, wherein the codes are to direct the processor to receive the game data from a plurality of external data sources, wherein the plurality of external data sources includes the external data source.

20. The non-transitory computer readable medium of claim 19, wherein the codes are to direct the processor to authenticate the game data received from each external data source of the plurality of external data sources.
